(19) United States
(12) Patent Application Publication
(10) Pub. No.: US 2026/0205010 A1
(43) Pub. Date: Jul. 16, 2026

(54) CHARGE PUMP CIRCUIT AND CHARGE PUMP DEVICE

(71) Applicant: EMEMORY TECHNOLOGY INC., HSINCHU (TW)

(72) Inventor: ZHE-YI LIN, HSINCHU COUNTY (TW)

(21) Appl. No.: 19/445,626

(22) Filed: Jan. 12, 2026

Related U.S. Application Data
(60) Provisional application No. 63/744,797, filed on Jan. 13, 2025.

(51) Int. Cl. H02M 3/07

(52) U.S. Cl. CPC H02M 3/07; H02M 3/073

(57) ABSTRACT

A charge pump circuit includes a first pump unit and a second pump unit. The first pump unit generates a pumped voltage according to an input voltage, a first clock signal, and a second clock signal. The first clock signal and the second clock signal are in phase, and the second clock signal has a higher swing than that of the first clock signal. The second pump unit has a structure similar to that of the first pump unit, and the first and the second pump units alternatively output a pumped voltage according to the input voltage. Transistors in the first pump unit and the second pump unit are operating within their safe operation area (SOA) and are disposed in two wells that are biased independently.

### CROSS REFERENCE

This application claims the benefit of prior-filed U.S. provisional application No. 63/744,797, filed on January 13, 2025, which is incorporated by reference in its entirety.

### TECHNICAL FIELD

The present disclosure relates to a charge pump circuit, and more particularly, to a charge pump circuit suitable for low voltage environment.

### DISCUSSION OF THE BACKGROUND

In response to the need for low power consumption in electronic devices, integrated circuits (IC) have been re-designed to operate in low voltage environments. While lower voltages are beneficial for reducing power consumption, there are still situations where greater voltages are necessary. For example, flash memory may require a high voltage (either positive or negative) for performing program operation or erase operation, and such high voltage is typically supplied by a charge pump.

However, to design a charge pump that works in the low voltage environment can be challenging. For example, special care may need to be taken to ensure that the transistors used in the circuit can operate within their safe operating areas (SOA). Also, efficient charge transferring for each stage of the charge pump can be crucial when operating in the low voltage environment. Therefore, how to design an efficient charge pump that can operates in the low voltage environment has become an issue to be solved.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a charge pump circuit. The charge pump circuit includes an input terminal for receiving an input voltage, an output terminal for outputting an output voltage, a first pump unit, a first output transistor, a second pump unit, and a second output transistor. The first pump unit includes a first capacitor, a second capacitor, a first transistor, a second transistor, and a first auxiliary control unit. The first capacitor has a first terminal configured to receive a first clock signal, and a second terminal. The second capacitor has a first terminal configured to receive a second clock signal, and a second terminal. The first transistor has a first terminal coupled to the input terminal, a second terminal coupled to the second terminal of the first capacitor, and a control terminal coupled to the second terminal of the second capacitor. The second transistor has a first terminal coupled to the second terminal of the second capacitor, a second terminal coupled to the second terminal of the first transistor, and a control terminal. The first auxiliary control unit is coupled to the control terminal of the second transistor, and configured to turn on the second transistor when the first clock signal is at a first high voltage, and turn off the second transistor when the first clock signal is at a low voltage. The first output transistor has a first terminal coupled to the second terminal of the first transistor, a second terminal coupled to the output terminal, and a control terminal. The second pump unit includes a third capacitor, a fourth capacitor, a third transistor, a fourth transistor, and a second auxiliary control unit. The third capacitor has a first terminal configured to receive a third clock signal, and a second terminal. The fourth capacitor has a first terminal configured to receive a fourth clock signal, and a second terminal. The third transistor has a first terminal coupled to the input terminal, a second terminal coupled to the second terminal of the third capacitor and the control terminal of the first output transistor, and a control terminal coupled to the second terminal of the fourth capacitor. The fourth transistor has a first terminal coupled to the second terminal of the fourth capacitor, a second terminal coupled to the second terminal of the third transistor, and a control terminal. The second auxiliary control unit is coupled to the control terminal of the fourth transistor, and configured to turn on the fourth transistor when the third clock signal is at the first high voltage, and turn off the fourth transistor when the third clock signal is at the low voltage. The second output transistor has a first terminal coupled to the second terminal of the third transistor, a second terminal coupled to the output terminal, and a control terminal coupled to the second terminal of the first transistor. The first clock signal and the second clock signal are in phase, the third clock signal and the fourth clock signal are in phase, the first clock signal and the third clock signal are out of phase, the second clock signal has a higher swing than that of the first clock signal, and the fourth clock signal has a higher swing than that of the third clock signal. The first transistor and the second transistor are disposed in a first well, and the third transistor and the fourth transistor are disposed in a second well.

Another aspect of the present disclosure provides a charge pump device. The charge pump device includes a plurality stages of charge pump circuit, and an input terminal of a latter stage being connected to an output terminal of a previous stage. A first stage of charge pump circuit of the plurality stages of charge pump circuit includes an input terminal for receiving an input voltage, an output terminal for outputting an output voltage, a first pump unit, a first output transistor, a second pump unit, and a second output transistor. The first pump unit includes a first capacitor, a second capacitor, a first transistor, a second transistor, and a first auxiliary control unit. The first capacitor has a first terminal configured to receive a first clock signal, and a second terminal. The second capacitor has a first terminal configured to receive a second clock signal, and a second terminal. The first transistor has a first terminal coupled to the input terminal, a second terminal coupled to the second terminal of the first capacitor, and a control terminal coupled to the second terminal of the second capacitor. The second transistor has a first terminal coupled to the second terminal of the second capacitor, a second terminal coupled to the second terminal of the first transistor, and a control terminal. The first auxiliary control unit is coupled to the control terminal of the second transistor, and configured to turn on the second transistor when the first clock signal is at a first high voltage, and turn off the second transistor when the first clock signal is at a low voltage. The first output transistor has a first terminal coupled to the second terminal of the first transistor, a second terminal coupled to the output terminal, and a control terminal. The second pump unit includes a third capacitor, a fourth capacitor, a third transistor, a fourth transistor, and a second auxiliary control unit. The third capacitor has a first terminal configured to receive a third clock signal, and a second terminal. The fourth capacitor has a first terminal configured to receive a fourth clock signal, and a second terminal. The third transistor has a first terminal coupled to the input terminal, a second terminal coupled to the second terminal of the third capacitor and the control terminal of the first output transistor, and a control terminal coupled to the second terminal of the fourth capacitor. The fourth transistor has a first terminal coupled to the second terminal of the fourth capacitor, a second terminal coupled to the second terminal of the third transistor, and a control terminal. The second auxiliary control unit is coupled to the control terminal of the fourth transistor, and configured to turn on the fourth transistor when the third clock signal is at the first high voltage, and turn off the fourth transistor when the third clock signal is at the low voltage. The second output transistor has a first terminal coupled to the second terminal of the third transistor, a second terminal coupled to the output terminal, and a control terminal coupled to the second terminal of the first transistor. The first clock signal and the second clock signal are in phase, the third clock signal and the fourth clock signal are in phase, the first clock signal and the third clock signal are out of phase, the second clock signal has a higher swing than that of the first clock signal, and the fourth clock signal has a higher swing than that of the third clock signal. The first transistor and the second transistor are disposed in a first well, and the third transistor and the fourth transistor are disposed in a second well.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows a charge pump circuit according to one embodiment of the present disclosure.

FIG. 2 shows waveforms of voltages and signals of the pump unit in FIG. 1 according to one embodiment of the present disclosure.

FIG. 3 shows well voltage selection units of the pump unit in FIG. 1 according to one embodiment of the present disclosure.

FIG. 4 shows a charge pump circuit according to another embodiment of the present disclosure.

FIG. 5 shows waveforms of voltages and signals of the pump unit in FIG. 4 according to one embodiment of the present disclosure.

FIG. 6 shows waveforms of the clock signals according to one embodiment of the present disclosure.

FIG. 7 shows a charge pump device according to one embodiment of the present disclosure.

### DETAILED DESCRIPTION

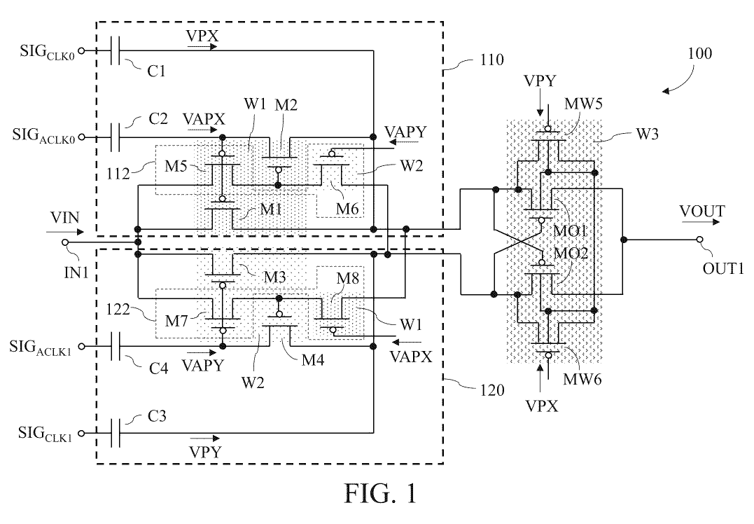

FIG. 1 shows a charge pump circuit 100 according to one embodiment of the present disclosure. The charge pump circuit 100 includes an input terminal IN1, an output terminal OUT1, pump units 110, 120, and output transistors MO1 and MO2. The input terminal IN1 receives an input voltage VIN, and the output terminal OUT1 outputs a positive output voltage VOUT that is higher than the input voltage VIN.

The pump unit 110 can employ two clock signals SIG_{CLK0} and SIG_{ACLK0} to boost the input voltage VIN and generate the positive output voltage VOUT. The clock signals SIG_{CLK0} and SIG_{ACLK0} are in phase, however, the swing of the clock signal SIG_{ACLK0} is greater than the swing of the clock signal SIG_{CLK0}. In such case, the pump unit 110 can utilize the clock signal SIG_{CLK0} to boost the voltage and utilize the clock signal SIG_{ACLK0} having a greater swing to control the transistor therein so that the transistor can be fully turned on during the charge transferring. Therefore, the pumped voltage can be mostly delivered by the charge pump circuit 100 to generate the output voltage VOUT. That is, the charge pump circuit 100 is able to achieve better charge transferring, making it suitable for low power application. Furthermore, with the proper design of the pump units 110 and 120, the transistors therein can operate in their safe operation area (SOA) with respect to the operational voltage VDD of the system so as to allow the charge pump circuit 100 to be implemented by low-voltage transistors having thin oxides.

As shown in FIG. 1, the pump unit 110 includes a capacitor C1, a capacitor C2, a transistor M1, a transistor M2, and an auxiliary control unit 112. The capacitor C1 has a first terminal for receiving the clock signal SIG_{CLK0}, and a second terminal. The capacitor C2 has a first terminal for receiving the clock signal SIG_{ACLK0}, and a second terminal. The transistor M1 has a first terminal coupled to the input terminal IN1, a second terminal coupled to the second terminal of the capacitor C1, and a control terminal coupled to the second terminal of the capacitor C2. The transistor M2 has a first terminal coupled to the second terminal of the capacitor C2, a second terminal coupled to the second terminal of the transistor M1, and a control terminal. The auxiliary control unit 112 is coupled to the control terminal of the transistor M2. The auxiliary control unit 112 can turn on the transistor M2 when the clock signal SIG_{CLK0} is at a first high voltage VH1, and can turn off the transistor M2 when the clock signal SIG_{CLK0} is at a low voltage VL. The output transistor MO1 has a first terminal coupled to the second terminal of the transistor M1, a second terminal coupled to the output terminal OUT1, and a control terminal. The output transistor MO1 can be turned on when the clock signal SIG_{CLK0} is at the high voltage VH1 so as to output the voltage VPX at the second terminal of the transistor M1 (i.e., the voltage at the second terminal of the capacitor C1) as the output voltage VOUT, and can be turned off when the clock signal SIG_{CLK0} is at the low voltage VL.

The pump unit 120 includes a capacitor C3, a capacitor C4, a transistor M3, a transistor M4, and an auxiliary control unit 122. The capacitor C3 has a first terminal for receiving the clock signal SIG_{CLK1}, and a second terminal. The capacitor C4 has a first terminal for receiving the clock signal SIG_{ACLK1}, and a second terminal. The transistor M3 has a first terminal coupled to the input terminal IN1, a second terminal coupled to the second terminal of the capacitor C3 and the control terminal of the output transistor MO1, and a control terminal coupled to the second terminal of the capacitor C4. The transistor M4 has a first terminal coupled to the second terminal of the capacitor C4, a second terminal coupled to the second terminal of the transistor M3, and a control terminal. The auxiliary control unit 122 is coupled to the control terminal of the transistor M4. The auxiliary control unit 122 can turn on the transistor M4 when the clock signal SIG_{CLK1} is at a first high voltage VH1, and can turn off the transistor M4 when the clock signal SIG_{CLK1} is at a low voltage VL. The output transistor MO2 has a first terminal coupled to the second terminal of the transistor M3, a second terminal coupled to the output terminal OUT1, and a control terminal coupled to second terminal of the transistor M1. The output transistor MO2 can be turned on when the clock signal SIG_{CLK1} is at the high voltage VH1 so as to output the voltage VPY at the second terminal of the transistor M3 (i.e., the voltage at the second terminal of the capacitor C3) as the output voltage VOUT, and can be turned off when the clock signal SIG_{CLK1} is at the low voltage VL.

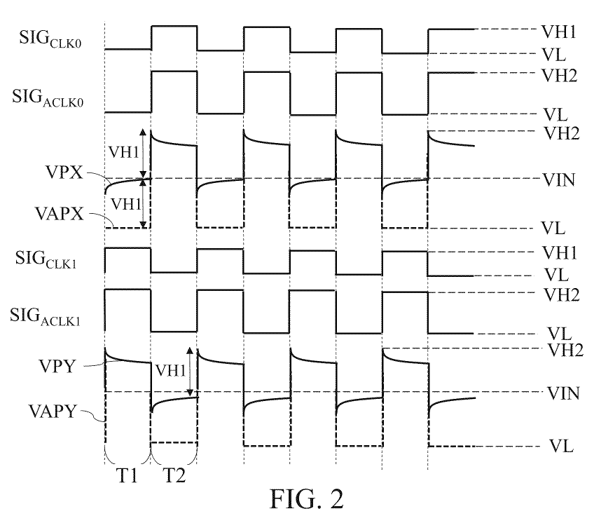

FIG. 2 shows waveforms of voltages and signals of the pump units 110 and 120 according to one embodiment of the present disclosure. As shown in FIG. 2, the clock signal SIG_{CLK0} and the clock signal SIG_{ACLK0} are in phase. The clock signal SIG_{CLK0} swings between the low voltage VL and the high voltage VH1, and the clock signal SIG_{ACLK0} swings between the low voltage VL and the high voltage VH2 higher than the voltage VH1. In some embodiments, a difference between the voltage VH2 and the voltage VL can be two times a difference between the voltage VH1 and the voltage VL. For example, the voltage VL can be 0V, and the voltage VH2 can be 2VH1. In some embodiments, the voltage VH1 can be the system operational voltage VDD. However, the present disclosure is not limited thereto.

In the period T1 shown in FIG. 2, the clock signal SIG_{CLK0}and the clock signal SIG_{ACLK0} are at the low voltage VL. In such case, the transistor M2 is turned off by the auxiliary control unit 112, and the voltage VAPX at the second terminal of the capacitor C2 is coupled to a low voltage as the clock signal SIG_{ACLK0} drops from the high voltage VH2 to the low voltage VL. Therefore, the voltage VAPX can fully turn on the transistor M1. In the present disclosure, since the clock signal SIG_{ACLK0} is used for turning on the transistor M1 for passing the input voltage VIN, the clock signal SIG_{ACLK0} is also referred to a passing clock signal.

As a result, although the voltage VPX at the second terminal of the transistor M1 may also be coupled to a low voltage in the beginning of the period T1 as the clock signal SIG_{CLK0} drops from the high voltage VH1 to the low voltage VL, the voltage VPX at the second terminal of the transistor M1 will be finally raised to be same as the input voltage VIN, which can be the system operational voltage VDD in the present embodiment. In addition, during the period T1, the output transistor MO1 is turned off, so the voltage VPX will not be outputted to the output terminal OUT1.

Subsequently, in period T2 after the period T1, the clock signal SIG_{CLK0} is raised to the high voltage VH1, and the clock signal SIG_{ACLK0} is raised to the high voltage VH2. In such case, both the voltages VAPX and VPX will be coupled to a higher voltage through the capacitors C1 and C2 as the clock signals SIG_{CLK0}and SIG_{ACLK0} raise, and thus, the pumped voltage VPX can be provided. In addition, since the transistor M2 is turned on by the auxiliary control unit 112 in the period T2, the voltage VAPX and the voltage VPX can be at the same level. Furthermore, in the period T2, when the clock signal SIG_{CLK0}is at the high voltage VH1 and the voltage VPX is boosted to be higher than the input voltage VIN, the voltage VPY at the second terminal of the transistor M3 is at the low voltage VL, so the output transistor MO1 can be turned on for outputting the pumped voltage VPX as the output voltage VOUT. Also, the output transistor MO2 can be turned off by the pumped voltage VPX, so the voltage VPY will not be outputted. In the present disclosure, since the clock signal SIG_{CLK0} is adopted to boost the voltage VPX to the voltage higher than the input voltage VIN, the clock signal SIG_{CLK0}is also referred to a boosting clock signal.

It may be noticed that in the present embodiment, since the output terminal OUT1 may be coupled to a load, the output voltage VOUT (i.e., the voltage VPX) may be gradually dropped due to the load. By proper design, the clock signals SIG_{CLK0} and SIG_{ACLK0} will return to the low voltage VL before the output voltage VOUT dropped to an unacceptable voltage, and the clock signals SIG_{CLK1} and SIG_{ACLK1} will change to the high voltages VH1 and VH2, thereby allowing the pump unit 120 to provide the pumped voltage VPY as the output voltage VOUT.

In other words, while the pump unit 110 outputs the pumped voltage VPX as the output voltage VOUT when the clock signal SIG_{CLK0} is at the high voltage VH1 and the clock signal SIG_{CLK1} is at the low voltage VL, the pump unit 120 can output the pumped voltage VPY as the output voltage VOUT when the clock signal SIG_{CLK0} is at the low voltage VL and the clock signal SIG_{CLK1} is at the high voltage VH1. Consequently, the charge pump circuit 100 can continuously output the pumped output voltage VOUT.

Specifically, the pump unit 120 and the pump unit 110 can have same structures but operate with different groups of clock signals that are complementary to each other. As shown in FIG. 2, the clock signal SIG_{CLK0}and the clock signal SIG_{CLK1} are out of phase, and the clock signal SIG_{CLK1} and the clock signal SIG_{ACLK1} are in phase. In addition, the clock signal SIG_{CLK1} swings between the low voltage VL and the high voltage VH1, and the clock signal SIG_{ACLK1} swings between the low voltage VL and the high voltage VH2. That is, the swing of the passing clock signal SIG_{ACLK1} is greater than the swing of the boosting clock signal SIG_{CLK1}. As the operation of the pump unit 120 is substantially similar to that of the pump unit 110 as described above, a detailed description thereof is omitted for the sake of brevity.

In some embodiments, the transistors M1, M2, M3, and M4 can be P-type transistors, such as PMOSFETs. In such case, since the waveforms of the voltages received by the transistors M1 and M2 for providing the pumped voltage VPX are out of phase with the waveforms of the voltages received by of the transistors M3 and M4 for providing the pumped voltage VPY, the body terminals of the transistors M1 and M2 and the body terminals of the transistors M3 and M4 can be biased differently, thereby preventing the leakage currents caused by the forward-biasing of PN junctions in the transistors M1, M2, M3, and M4. In some embodiments, the transistor M1 and M2 may be disposed in a well W1 (represented by a dense dotted region), such as an N well, while the transistors M3 and M4 may be disposed in a well W2 (represented by a sparse dotted region) such as another N well.

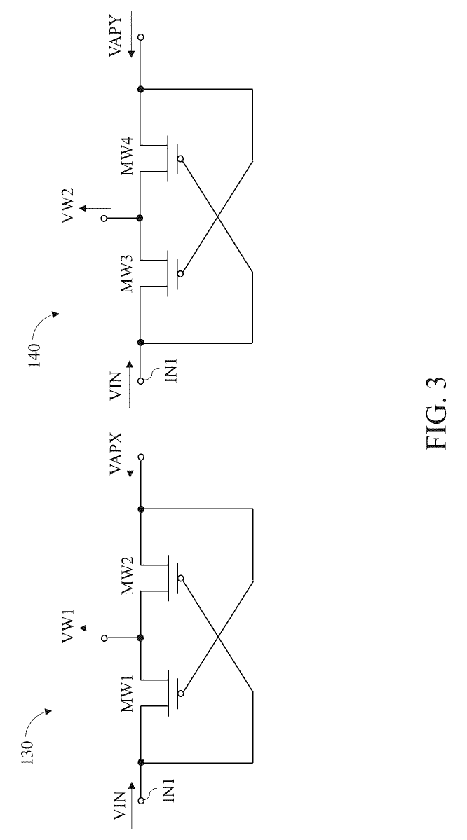

In some embodiments, the charge pump circuit 100 may further include well voltage selection units for providing well voltages to the well W1 and the well W2. FIG. 3 shows well voltage selection units 130 and 140 for providing the well voltages to the well W1 and the well W2 according to one embodiment of the present disclosure. In the present embodiment, the well voltage selection unit 130 can generate a well voltage VW1 to the well W1 for the transistors M1 and M2 according to a higher one of the input voltage VIN and the voltage VAPX at the first terminal of the transistor M2 (i.e., the voltage at the second terminal of the capacitor C2). Thus, the body terminals of the transistor M1 and M2 can both receive the well voltage VW1 (not shown in FIG. 1 for brevity). Also, the well voltage selection unit 140 can generate a well voltage VW2 to the well W2 for the transistors M3 and M4 according to a higher one of the input voltage VIN and the voltage VAPY at the first terminal of the transistor M4 (i.e., the voltage at the second terminal of the capacitor C4). Thus, the body terminals of the transistor M3 and M4 can both receive the well voltage VW2 (not shown in FIG. 1 for brevity).

Specifically, the well voltage selection unit 130 may include well-select transistors MW1 and MW2, which may be disposed in the well W1. The well-select transistor MW1 has a first terminal coupled to the input terminal IN1, a second terminal for outputting the well voltage VW1, and a control terminal. The well-select transistor MW2 has a first terminal coupled to the second terminal of the well-select transistor MW1, a second terminal coupled to the second terminal of the capacitor C2 for receiving the voltage VAPX and also coupled to the control terminal of the well-select transistor MW1, and a control terminal coupled to the first terminal of the well-select transistor MW1.

In such case, when the input voltage VIN is lower than the voltage VAPX, the well-select transistor MW2 can be turned on and the well-select transistor MW1 can be turned off. As a result, the well voltage selection unit 130 can output the voltage VAPX as the well voltage VW1. Conversely, when the input voltage VIN is higher than the voltage VAPX, the well-select transistor MW1 can be turned on and the well-select transistor MW2 can be turned off. As a result, the well voltage selection unit 130 can output the input voltage VIN as the well voltage VW1.

Similarly, the well voltage selection unit 140 includes well-select transistors MW3 and MW4, which may be disposed in the well W2. The well-select transistor MW3 has a first terminal coupled to the input terminal IN1, a second terminal for outputting the well voltage VW2, and a control terminal. The well-select transistor MW4 has a first terminal coupled to the second terminal of the well-select transistor MW3, a second terminal coupled to the second terminal of the capacitor C4 for receiving the voltage VAPY and also coupled to the control terminal of the well-select transistor MW3, and a control terminal coupled to the first terminal of the well-select transistor MW3.

In the present embodiment, the output transistors MO1 and MO2 can also be P-type transistors, such as PMOSFETs, and can have their body terminals biased independently from the transistors M1, M2, M3, and M4. As shown in FIG. 1, the charge pump circuit 100 can further include well-select transistors MW5 and MW6 so as to ensure that the body terminals of the output transistors MO1 and MO2 are at a higher voltage, thereby preventing the cause of current leakage.

As shown in FIG. 1, the well-select transistor MW5 has a first terminal coupled to the first terminal of the output transistor MO1, a second terminal, a control terminal coupled to the second terminal of the capacitor C3 for receiving the voltage VPY, and a body terminal coupled to the second terminal of the well-select transistor MW5 and the body terminal of the output transistor MO1. The well-select transistor MW6 has a first terminal coupled to the first terminal of the output transistor MO2, a second terminal coupled to the second terminal of the well-select transistor MW5, a control terminal coupled to the second terminal of the capacitor C1 for receiving the voltage VPX, and a body terminal coupled to the second terminal of the well-select transistor MW6 and the body terminal of the output transistor MO2. As a result, the body terminals of the well-select transistors MW5, MW6, and the body terminals of the output transistors MO1 and MO2 will be tied to the higher one of the voltage VPX and VPY, thereby preventing the cause of current leakage. In some embodiments, the well-select transistors MW5, MW6 and the output transistors MO1 and MO2 can be disposed in a well W3, such as an N well, different from the well W1 that accommodates the transistors M1 and M2 and different from the well W2 that accommodates the transistors M3 and M4.

As shown in FIG. 1, the auxiliary control unit 112 includes a transistor M5 and a transistor M6. The transistor M5 has a first terminal coupled to the input terminal IN1, a second terminal coupled to the control terminal of the transistor M2, and a control terminal coupled to the second terminal of the capacitor C2. The transistor M6 has a first terminal coupled to the control terminal of the transistor M2, a second terminal coupled to the second terminal of the capacitor C3, and a control terminal coupled to the second terminal of the capacitor C4.

Refer to FIG. 1 and FIG. 2. In the period T1 when the clock signal SIG_{ACLK0} is at the low voltage VL, the clock signal SIG_{ACLK1} is at the high voltage VH2, the voltage VAPX is coupled to a low level (e.g., the low voltage VL), and the voltage VAPY is coupled to a high level (e.g., a level close to the high voltage VH2). In such case, the transistor M5 can be turned on by the voltage VAPX, and the transistor M6 can be turned off by the voltage VAPY. Therefore, the control terminal of the transistor M2 would receive the input voltage VIN and would be turned off in the period T1.

In addition, in the period T2 when the clock signal SIG_{ACLK0} is at the high voltage VH2, the clock signal SIG_{ACLK1} is at the low voltage VL, the voltage VAPY is coupled to a low level (e.g., the low voltage VL), and the voltage VAPX is coupled to a high level (e.g., a level close to the high voltage VH2). In such case, the transistor M5 will be turned off by the voltage VAPX, and the transistor M6 can be turned on by the voltage VAPY. Therefore, the control terminal of the transistor M2 would receive the voltage VPY, which is coupled to the low level, and thus, the transistor M2 can be turned on in the period T2, thereby allowing the voltage VAPX at the second terminal of the capacitor C2 to be same as the voltage VPX at the second terminal of the capacitor C1.

In the present embodiment, the gate-to-source voltages and the gate-to-drain voltages of the transistors M1, M2, M5, and M6 can be kept within the operational voltage VDD, thereby allowing the transistors M1, M2, M5, and M6 be implemented by low-voltage transistors having thin oxide while operating in their safe operating area (SOA).

The auxiliary control unit 122 and the auxiliary control unit 112 have same structures. In the present embodiment, the auxiliary control unit 122 includes a transistor M7 and a transistor M8. The transistor M7 has a first terminal coupled to the input terminal IN1, a second terminal coupled to the control terminal of the transistor M4, and a control terminal coupled to the second terminal of the capacitor C4. The transistor M8 has a first terminal coupled to the control terminal of the transistor M4, a second terminal coupled to the second terminal of the capacitor C1, and a control terminal coupled to the second terminal of the capacitor C2. Since the operation of the auxiliary control unit 122 is substantially similar to that of the auxiliary control unit 112 as described above, a detailed description thereof is omitted for the sake of brevity.

In some embodiments, the transistors M5 and M8 can be disposed in the same well as the transistors M1 and M2, and the transistor M6 and M7 can be disposed in the same well as the transistors M3 and M4. In such case, the charge pump circuit 100 may include three wells. The transistors M1, M2, M5 and M8, and the well-select transistor MW1 and MW2 can be disposed in the well W1 that can be biased by the well voltage VW1 provided by the well voltage selection unit 130. Also, the transistors M3, M4, M6 and M7, and the well-select transistor MW3 and MW4 can be disposed in the well W2 that can be biased by the well voltage VW2 provided by the well voltage selection unit 140. In addition, the output transistors MO1, MO2, and the well-select transistors MW5 and MW6 can be disposed in the well W3 that can be biased by the well-select transistors MW5 and MW6.

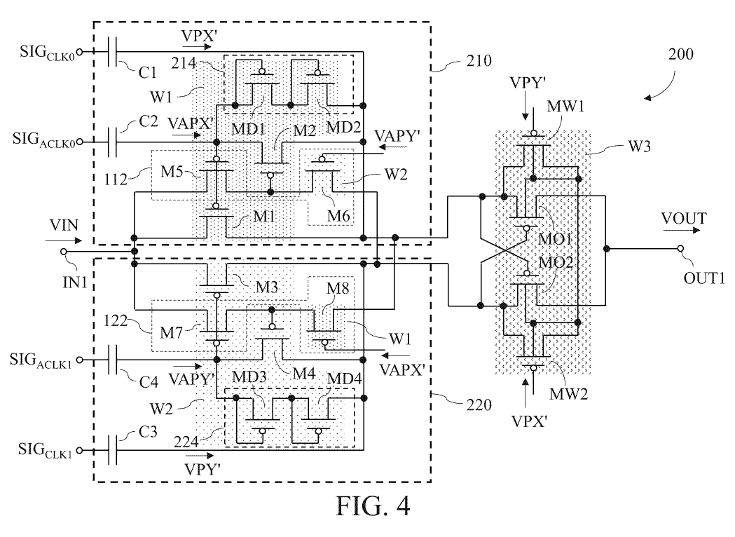

FIG. 4 shows a charge pump circuit 200 according to another embodiment of the present disclosure. The charge pump circuit 200 is different from the charge pump circuit 100 in that the pump unit 210 of the charge pump circuit 200 further includes a voltage gap unit 214 and the pump unit 220 of the charge pump circuit 200 further includes a voltage gap unit 224.

The voltage gap unit 214 is coupled between the second terminal of the capacitor C2 and the second terminal of the transistor M1. The voltage gap unit 214 is configured to let the voltage VAPX' at the second terminal of the capacitor C2 be lower than the voltage VPX' at the second terminal of the transistor M1 by a gap voltage VG when the clock signal SIG_{CLK0} is at the low voltage VL. The voltage gap unit 224 is coupled between the second terminal of the capacitor C4 and the second terminal of the transistor M3. The voltage gap unit 224 is configured to let the voltage VAPY' at the second terminal of the capacitor C4 be lower than the voltage VPY' at the second terminal of the transistor M3 by the gap voltage VG when the clock signal SIG_{CLK1} is at the low voltage VL.

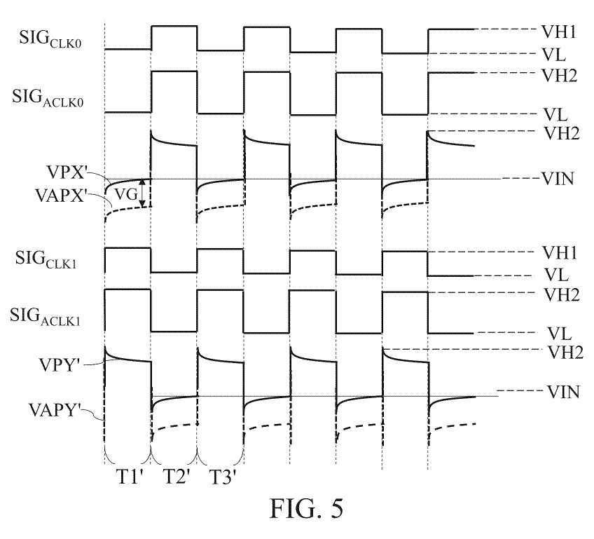

FIG. 5 shows waveforms of voltages and signals of the pump unit 210 and the pump unit 220 according to one embodiment of the present disclosure. In the period T1', the clock signal SIG_{CLK0} and SIG_{ACLK0} are both at the low voltage VL, the transistor M1 is turned on and the transistor M2 is turned off, and the voltage VPX can become same as the input voltage VIN. In such case, without the voltage gap unit 214, the voltage VAPX in the period T1 shown in FIG. 2 may be at the low level VL that lower than the voltage VPX by the voltage VH1; however, as shown in FIG. 5, the voltage VAPX' in the period T1' is lower than the voltage VPX' by a gap voltage VG provided by the voltage gap unit 214. In the present embodiment, the input voltage VIN minus the gap voltage VG can be higher than the low voltage VL, so the voltage VAPX' in the period T1' shown in FIG. 5 can be at a level higher than the level of the voltage VAPX in the period T1 shown in FIG. 2. In some embodiments, the gap voltage VG can be greater than a threshold voltage of the transistor M1, so that the voltage VAPX' can still fully turn on the transistor M1.

Since the voltage VAPX' in the period T1' shown in FIG. 5 can be at a level higher than the level of the voltage VAPX in the period T1 shown in FIG. 2, when the clock signal SIG_{ACLK0} changes from the low voltage VL to the high voltage VH2 in the period T2', the voltage VAPX' would be expected to be raised to a level higher than the voltage VPX'. In such case, the pull-up driving force provided to the voltage VAPX' can help the voltage VPX' to reach the targeted pumped voltage level (e.g., the voltage VH2) sooner as the transistor M2 is turned on during the period T2'.

Similarly, the voltage gap unit 224 can have the voltage VAPY' raised to a higher level in the period T2'. Therefore, when the clock signal SIG_{ACLK1} changes from the low voltage VL to the high voltage VH2 in the period T3', the voltage VAPY' would be expected to be raised to a level higher than the voltage VPY', thereby assisting the voltage VPY' to reach the targeted pumped voltage level sooner.

In some embodiments, each of the voltage gap units 214 and 224 may include at least one diode or at least one diode-connected transistor for providing the gap voltage VG. As shown in FIG. 4, the voltage gap unit 214 includes diode-connected transistors MD1 and MD2. The diode-connected transistor MD1 has a first terminal coupled to the second terminal of the capacitor C2, a second terminal, and a control terminal coupled to the first terminal of the diode-connected transistor MD1. The diode-connected transistor MD2 has a first terminal coupled to the second terminal of the diode-connected transistor MD1, a second terminal coupled to the second terminal of the transistor M1, and a control terminal coupled to the first terminal of the diode-connected transistor MD2.

In such case, the gap voltage VG provided by the voltage gap unit 214 would be equal to the sum of the threshold voltages of the diode-connected transistors MD1 and MD2. In the present embodiment, the threshold voltages of the diode-connected transistors MD1 and MD2 can be same as the threshold voltage of the transistor M1, in other words, it may allow the design to be much easier for having the transistors M1, MD1 and MD2 be devices of the same type. Therefore, in the end of the time period T1', the voltage VAPX' may be lower than the voltage VPX' by two times the threshold voltage, thereby ensuring the transistor M1 can be fully turned on. In addition, in the present embodiment, the diode-connected transistors MD1 and MD2 can also help to ensure the drain-to-source voltage of the transistor M2 to remain within its SOA.

In the present embodiment, the voltage gap unit 224 can have the same structure as the voltage gap unit 214. That is, the voltage gap unit 224 can also adopt two diode-connected transistors MD3 and MD4 coupled in series. However, in some embodiments, the transistors MD1, MD2, MD3, and MD4 can be replaced by diodes.

In some embodiments, the diode-connected transistors MD1 and MD2 can be disposed in the well W1 as the transistor M1, M2 and M5, and the diode-connected transistors MD3 and MD4 can be disposed in the well W2 as the transistor M3, M4 and M7.

Furthermore, unlike the transistors M1 and M3 and the output transistors MO1 and MO2 that are used to output the output voltage VOUT with higher currents, the rest of transistors M2, M4, M5, M6, M7, M8 the well-select transistors MW1, MW2, MW3, MW4, MW5, MW6 and the diode-connected transistors MD1, MD2, MD3, and MD4 are used to adjust the voltages with lower currents. Therefore, in some embodiments, the sizes (e.g., effective channel widths) of the transistors M1 and M3 and the output transistors MO1 and MO2 can be greater than the sizes (e.g., effective channel widths) of the transistors M2, M4, M5, M6, M7, M8, the well-select transistors MW1, MW2, MW3, MW4, MW5, MW6 and the diode-connected transistors MD1, MD2, MD3, and MD4. In other words, the transistors M2, M4, M5, M6, M7, M8, MW1, MW2, MW3, MW4, MW5, MW6, MD1, MD2, MD3, and MD4 can have smaller sizes so as to reduce the total area of the charge pump circuit 100.

In some embodiments, since all transistors in the charge pump circuits 100 and 200 can operate with the gate-to-drain voltage, the gate-to-source voltage, and the drain-to-source voltage being smaller than or equal to the system operational voltage VDD (for example but not limited to under 1.2V), all transistors in the charge pump circuits 100 and 200 can be implemented by low-voltage transistors that have thin gate oxides.

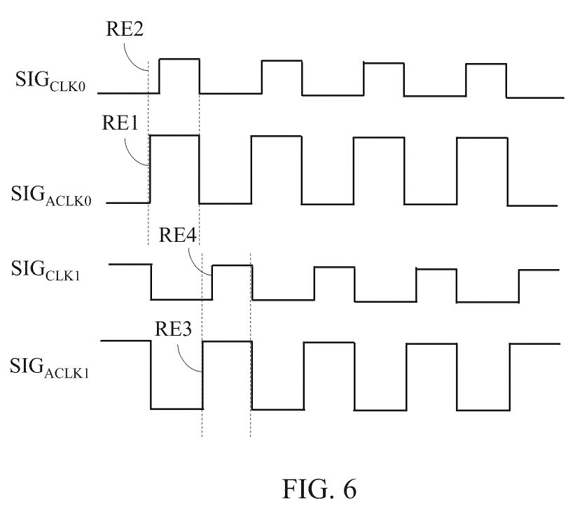

In addition, in some embodiment, to improve the efficiency of the charge pump circuit 100 or 200, the rising edge of the clock signal SIG_{ACLK0} may lead the rising edge of the clock signal SIG_{CLK0}, and the rising edge of the clock signal SIG_{ACLK1} may lead the rising edge of the clock signal SIG_{CLK1}. FIG. 6 shows waveforms of the clock signals SIG_{CLK0}, SIG_{ACLK0}, SIG_{CLK1}, and SIG_{ACLK1} according to one embodiment of the present disclosure. As shown in FIG. 6, a rising edge RE1 of the clock signal SIG_{ACLK0} leads a rising edge RE2 of the clock signal SIG_{CLK0}. In such case, the transistor M1 can be turned off first at the rising edge RE1 before the rising edge RE2, thereby allowing the voltage VPX to be coupled to the high voltage VH2 sooner and firmer at the rising edge RE2. Similarly, rising edge RE3 of the clock signal SIG_{ACLK1} can lead a rising edge RE4 of the clock signal SIG_{CLK1}, so as to improve the efficiency of the charge pump circuits 100 and 200.

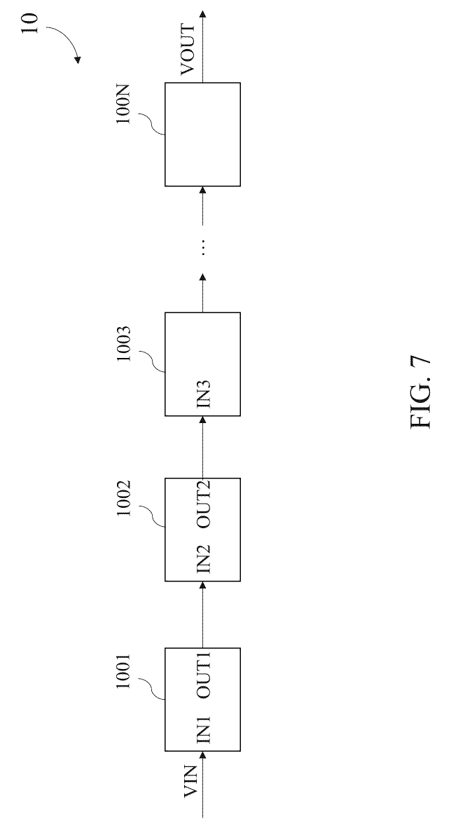

In some embodiments, the charge pump circuits 100 and 200 can be cascaded to generate a pumped output voltage at an even higher level. FIG. 7 shows a charge pump device 10 according to one embodiment of the present disclosure. The charge pump device 10 includes a plurality stages of charge pump circuits 1001 to 100N.

In the present embodiment, each stage of the charge pump circuits 1001 to 100N can be implemented by the charge pump circuit 100 shown in FIG. 1 or the charge pump circuit 200 shown in FIG. 4. In the present embodiment, an input terminal IN1 of the charge pump circuit 1001 may receive the input voltage VIN, an output terminal OUT1 of the charge pump circuit 1001 is coupled to an input terminal IN2 of the charge pump circuit 1002, an output terminal OUT2 of the charge pump circuit 1002 is coupled to an input terminal IN3 of the charge pump circuit 1003, and so on. Finally, the charge pump circuit 100N can output the output voltage VOUT. In the present embodiment, with the aid of the passing clock signals SIG_{ACLK0} and SIG_{ACLK1} having greater swing amplitudes, each stage of the charge pump device 10 (i.e., each of the charge pump circuits 1001 to 100N) is able to raise the output voltage by a full voltage increment of VH1 provided by the boosting clock signals SIG_{CLK0} and SIG_{CLK1}. In such case, the output voltage provided by the charge pump circuit 1001 can be about 2VH1, the output voltage provided by the charge pump circuit 1002 can be about 3VH1, and so on.

In summary, the charge pump circuits and the charge pump devices provided by the embodiments of the present disclosure can adopt boosting clock signals and passing clock signals of two phases, so that each stage of the charge pump device is able to raise the output voltage by a full voltage increment provided by the swings of the boosting clock signals. That is, the charge pump circuits and the charge pump devices of the present disclosure can achieve better efficiency in terms of charge transferring, so that the charge pump circuits is particularly suitable for low power design. Furthermore, the charge pump circuits and the charge pump devices provided by the embodiments of the present disclosure can use the passing clock signals to assist the boosting of the output voltage, so as to further improve the efficiency of the charge pump circuits and the charge pump devices.

What is claimed is:

1. A charge pump circuit comprising:
an input terminal configured to receive an input voltage;
an output terminal configured to output an output voltage;
a first pump unit comprising:
a first capacitor having a first terminal configured to receive a first clock signal, and a second terminal;
a second capacitor having a first terminal configured to receive a second clock signal, and a second terminal;
a first transistor having a first terminal coupled to the input terminal, a second terminal coupled to the second terminal of the first capacitor, and a control terminal coupled to the second terminal of the second capacitor;
a second transistor having a first terminal coupled to the second terminal of the second capacitor, a second terminal coupled to the second terminal of the first transistor, and a control terminal; and
a first auxiliary control unit coupled to the control terminal of the second transistor, and configured to turn on the second transistor when the first clock signal is at a first high voltage, and turn off the second transistor when the first clock signal is at a low voltage;
a first output transistor having a first terminal coupled to the second terminal of the first transistor, a second terminal coupled to the output terminal, and a control terminal;
a second pump unit comprising:
a third capacitor having a first terminal configured to receive a third clock signal, and a second terminal;
a fourth capacitor having a first terminal configured to receive a fourth clock signal, and a second terminal;
a third transistor having a first terminal coupled to the input terminal, a second terminal coupled to the second terminal of the third capacitor and the control terminal of the first output transistor, and a control terminal coupled to the second terminal of the fourth capacitor;
a fourth transistor having a first terminal coupled to the second terminal of the fourth capacitor, a second terminal coupled to the second terminal of the third transistor, and a control terminal; and
a second auxiliary control unit coupled to the control terminal of the fourth transistor, and configured to turn on the fourth transistor when the third clock signal is at the first high voltage, and turn off the fourth transistor when the third clock signal is at the low voltage; and
a second output transistor having a first terminal coupled to the second terminal of the third transistor, a second terminal coupled to the output terminal, and a control terminal coupled to the second terminal of the first transistor;
wherein the first clock signal and the second clock signal are in phase, the third clock signal and the fourth clock signal are in phase, the first clock signal and the third clock signal are out of phase, the second clock signal has a higher swing than that of the first clock signal, and the fourth clock signal has a higher swing than that of the third clock signal;
wherein the first transistor and the second transistor are disposed in a first well, and the third transistor and the fourth transistor are disposed in a second well.

2. The charge pump circuit of claim 1, wherein:
the first clock signal and the third clock signal swing between the low voltage and the first high voltage, and the second clock signal and the fourth clock signal swing between the low voltage and a second high voltage higher than the first high voltage; and
a difference between the second high voltage and the low voltage is two times a difference between the first high voltage and the low voltage.

3. The charge pump circuit of claim 1, wherein:
the first output transistor is configured to be turned on to generate the output voltage according to a voltage at the second terminal of the first transistor when the first clock signal is at the first high voltage, and turned off when the first clock signal is at the low voltage; and
the second output transistor is configured to be turned on to generate the output voltage according to a voltage at the second terminal of the third transistor when the third clock signal is at the first high voltage, and turned off when the third clock signal is at the low voltage.

4. The charge pump circuit of claim 1, wherein the first auxiliary control unit comprises:
a fifth transistor having a first terminal coupled to the input terminal, a second terminal coupled to the control terminal of the second transistor, and a control terminal coupled to the second terminal of the second capacitor; and
a sixth transistor having a first terminal coupled to the control terminal of the second transistor, a second terminal coupled to the second terminal of the third capacitor, and a control terminal coupled to the second terminal of the fourth capacitor.

5. The charge pump circuit of claim 4, wherein the fifth transistor is disposed in the first well, and the sixth transistor is disposed in the second well.

6. The charge pump circuit of claim 4, wherein the second auxiliary control unit comprises:
a seventh transistor having a first terminal coupled to the input terminal, a second terminal coupled to the control terminal of the fourth transistor, and a control terminal coupled to the second terminal of the fourth capacitor; and
an eighth transistor having a first terminal coupled to the control terminal of the fourth transistor, a second terminal coupled to the second terminal of the first capacitor, and a control terminal coupled to the second terminal of the second capacitor.

7. The charge pump circuit of claim 6, wherein the fifth transistor and the eighth transistor are disposed in the first well, and the sixth transistor and the seventh transistor are disposed in the second well.

8. The charge pump circuit of claim 6, wherein the first transistor, the second transistor, the third transistor, the fourth transistor, the fifth transistor, the sixth transistor, the seventh transistor, and the eighth transistor are P-type transistors.

9. The charge pump circuit of claim 1, wherein the first well is biased by a first well voltage, and the second well is biased by a second well voltage, the charge pump circuit further comprises:
a first well voltage selection unit configured to generate the first well voltage to the first well according to a higher one of the input voltage and a voltage at the second terminal of the second capacitor; and
a second well voltage selection unit configured to generate the second well voltage to the second well according to a higher one of the input voltage and a voltage at the second terminal of the fourth capacitor.

10. The charge pump circuit of claim 9, wherein the first well voltage selection unit comprises:
a first well-select transistor having a first terminal coupled to the input terminal, a second terminal for outputting the first well voltage, and a control terminal; and
a second well-select transistor having a first terminal coupled to the second terminal of the first well-select transistor, a second terminal coupled to the second terminal of the second capacitor and the control terminal of the first well-select transistor, and a control terminal coupled to the first terminal of the first well-select transistor.

11. The charge pump circuit of claim 9, wherein the second well voltage selection unit comprises:
a third well-select transistor having a first terminal coupled to the input terminal, a second terminal for outputting the second well voltage, and a control terminal; and
a fourth well-select transistor having a first terminal coupled to the second terminal of the third well-select transistor, a second terminal coupled to the second terminal of the fourth capacitor and the control terminal of the third well-select transistor, and a control terminal coupled to the first terminal of the third well-select transistor.

12. The charge pump circuit of claim 1, further comprising:
a fifth well-select transistor having a first terminal coupled to the first terminal of the first output transistor, a second terminal, a control terminal coupled to the second terminal of the third capacitor, and a body terminal coupled to the second terminal of the fifth well-select transistor and a body terminal of the first output transistor; and
a sixth well-select transistor having a first terminal coupled to the first terminal of the second output transistor, a second terminal coupled to the second terminal of the fifth well-select transistor, a control terminal coupled to the second terminal of the first capacitor, and a body terminal coupled to the second terminal of the fifth well-select transistor, the second terminal of the sixth well-select transistor and a body terminal of the sixth well-select transistor.

13. The charge pump circuit of claim 1, wherein the first pump unit further comprises a voltage gap unit coupled between the second terminal of the second capacitor and the second terminal of the first transistor, and configured to let a voltage at the second terminal of the first transistor be higher than a voltage at the second terminal of the second capacitor by a gap voltage when the first clock signal is at the low voltage.

14. The charge pump circuit of claim 13, wherein the voltage gap unit comprises at least one diode or at least one diode-connected transistor.

15. The charge pump circuit of claim 13, wherein the voltage gap unit comprises:
a first diode-connected transistor having a first terminal coupled to the second terminal of the second capacitor, a second terminal, and a control terminal coupled to the first terminal of the first diode-connected transistor; and
a second diode-connected transistor having a first terminal coupled to the second terminal of the first diode-connected transistor, a second terminal coupled to the second terminal of the first transistor, and a control terminal coupled to the first terminal of the second diode-connected transistor.

16. The charge pump circuit of claim 15, wherein the first diode-connected transistor and the second diode-connected transistor are disposed in the first well.

17. The charge pump circuit of claim 12, wherein the fifth well-select transistor, the sixth well-select transistor, the first output transistor and the second output transistor are disposed in a third well different from the first well and the second well.

18. The charge pump circuit of claim 1, wherein a size of the first transistor is greater than a size of the second transistor and each size of transistors in the first auxiliary control unit.

19. A charge pump device comprising:
a plurality stages of charge pump circuit, and an input terminal of a latter stage being connected to an output terminal of a previous stage;
wherein a first stage of charge pump circuit comprises:
an input terminal configured to receive an input voltage;
an output terminal configured to output an output voltage;
a first pump unit comprising:
a first capacitor having a first terminal configured to receive a first clock signal, and a second terminal;
a second capacitor having a first terminal configured to receive a second clock signal, and a second terminal;
a first transistor having a first terminal coupled to the input terminal of the first stage of charge pump circuit, a second terminal coupled to the second terminal of the first capacitor, and a control terminal coupled to the second terminal of the second capacitor;
a second transistor having a first terminal coupled to the second terminal of the second capacitor, a second terminal coupled to the second terminal of the first transistor, and a control terminal; and
a first auxiliary control unit coupled to the control terminal of the second transistor, and configured to turn on the second transistor when the first clock signal is at a first high voltage, and turn off the second transistor when the first clock signal is at a low voltage;
a first output transistor having a first terminal coupled to the second terminal of the first transistor, a second terminal coupled to the output terminal of the first stage of charge pump circuit, and a control terminal;
a second pump unit comprising:
a third capacitor having a first terminal configured to receive a third clock signal, and a second terminal;
a fourth capacitor having a first terminal configured to receive a fourth clock signal, and a second terminal;
a third transistor having a first terminal coupled to the input terminal of the first stage of charge pump circuit, a second terminal coupled to the second terminal of the third capacitor and the control terminal of the first output transistor, and a control terminal coupled to the second terminal of the fourth capacitor;
a fourth transistor having a first terminal coupled to the second terminal of the fourth capacitor, a second terminal coupled to the second terminal of the third transistor, and a control terminal; and
a second auxiliary control unit coupled to the control terminal of the fourth transistor, and configured to turn on the fourth transistor when the third clock signal is at the first high voltage, and turn off the fourth transistor when the third clock signal is at the low voltage; and
a second output transistor having a first terminal coupled to the second terminal of the third transistor, a second terminal coupled to the output terminal of the first stage of charge pump circuit, and a control terminal coupled to the second terminal of the first transistor;
wherein the first clock signal and the second clock signal are in phase, the third clock signal and the fourth clock signal are in phase, the first clock signal and the third clock signal are out of phase, the second clock signal has a higher swing than that of the first clock signal, and the fourth clock signal has a higher swing than that of the third clock signal;
wherein the first transistor and the second transistor are disposed in a first well, and the third transistor and the fourth transistor are disposed in a second well.

20. The charge pump device of claim 19, wherein the output terminal of the first stage of charge pump circuit is coupled to an input terminal of a second stage of charge pump circuit of the plurality stages of charge pump circuits.
